(19) United States
(12) Patent Application Publication
(10) Pub. No.: US 2014/0369082 A1
(43) Pub. Date: Dec. 18, 2014

(54) POWER SUPPLY DEVICE

(71) Applicant: SAMSUNG ELECTRO-MECHANICS CO., LTD., Suwon (KR)

(72) Inventors: Jae Kuk KIM, Suwon (KR); Chong Eun KIM, Suwon (KR)

(73) Assignee: SAMSUNG ELECTRO-MECHANICS CO., LTD., Suwon (KR)

(21) Appl. No.: 14/035,279

(22) Filed: Sep. 24, 2013

(30) Foreign Application Priority Data
Jun. 18, 2013 (KR) 10-2013-0069781

(51) Int. Cl. H02M 3/335

(52) U.S. Cl. CPC H02M 3/335
USPC 363/21.02

(57) ABSTRACT

There is provided a power supply device, including an insulating direct current to direct current (DC/DC) converter unit including a primary side winding and a secondary side winding inductively coupled to the primary side winding and inducing a voltage in the secondary side winding in a first direction or a second direction, and a boost unit including a first boost converter boosting the voltage induced in the secondary side winding, in a first mode in which the voltage is induced in the secondary side winding in the first direction, and a second boost converter boosting the voltage induced in the secondary side winding, in a second mode in which the voltage is induced in the secondary side winding in the second direction.

### CROSS-REFERENCE TO RELATED APPLICATIONS

This application claims the priority of Korean Patent Application No. 10-2013-0069781 filed on Jun. 18, 2013, in the Korean Intellectual Property Office, the disclosure of which is incorporated herein by reference.

### BACKGROUND OF THE INVENTION

1. Field of the Invention

The present invention relates to a power supply device used for driving a light emitting diode (LED).

2. Description of the Related Art

As energy consumption has become a social issue, interest in energy-efficient light sources has increased. Therefore, research into light emitting diodes (LEDs) capable of replacing existing cold cathode fluorescent lamps (CCFLs) has been actively conducted. That is, by using LEDs in a backlight or similar unit of a lighting device or television, an effort to overcome inefficiency in existing CCFLs has been made.

In general, a plurality of LEDs are connected to one another in series or in parallel so as to be used. Therefore, a user may adjust a brightness of light depending on a situation.

In addition, in order to decrease current deviation between LED strings, a separate current driver is used for each string.

However, in a case of a LED driving device according to the related art, a great deal of components may be used, which results in a complicated circuit structure. In addition, when the respective drivers are used, it may be uneconomical in view of energy efficiency.

Therefore, an LED driving device in which the existing complicated structure is improved and is more efficient needs to be introduced.

Patent Document 1 described in the following related art document relates to an LED power supply device and Patent Document 2 relates to a multi-structure boost circuit, but neither thereof discloses a specific configuration for improving the complicated structure and more efficiently supplying the power.

### RELATED ART DOCUMENT

(Patent Document 1) U.S. Pat. No. 8,125,158
(Patent Document 2) Korean Patent Laid-Open Publication No. 2013-0008103

### SUMMARY OF THE INVENTION

An aspect of the present invention provides an LED power supply device having a simplified circuit structure.

Another aspect of the present invention provides an LED power supply device having improved efficiency.

According to an aspect of the present invention, there is provided a power supply device, including: an insulating direct current to direct current (DC/DC) converter unit including a primary side winding and a secondary side winding inductively coupled to the primary side winding and inducing a voltage in the secondary side winding in a first direction or a second direction; and a boost unit including a first boost converter boosting the voltage induced in the secondary side winding, in a first mode in which the voltage is induced in the secondary side winding in the first direction, and a second boost converter boosting the voltage induced in the secondary side winding, in a second mode in which the voltage is induced in the secondary side winding in the second direction.

The insulating DC/DC converter unit may include a half-bridge DC/DC converter or a full-bridge DC/DC converter.

The boost unit may include a common inductor having one end connected to one end of the secondary side winding in series.

The boost unit may include a first switching element and a first diode connected to the other end of the secondary side winding.

The boost unit may include a second switching element and a second diode connected to the other end of the common inductor.

The power supply device may further include a controlling unit controlling the insulating DC/DC converter unit and the boost unit.

The controlling unit may turn on the second switching element in the first mode.

The controlling unit may turn on the first switching element in the second mode.

The half-bridge DC/DC converter may include a third switching element and a fourth switching element, and the controlling unit may turn off the third switching element and after a predetermined time of interval has elapsed, turn on the fourth switching element, and may turn off the fourth switching element and after a predetermined time of interval has elapsed, turn on the third switching element.

According to another aspect of the present invention, there is provided a power supply device, including: an insulating direct current to direct current (DC/DC) converter unit including a primary side winding and a secondary side winding inductively coupled to the primary side winding and inducing a voltage in the secondary side winding in a first direction or a second direction; a common inductor connected to the secondary side winding in series; a first boost converter including a first switching element controlling accumulating and discharging of energy of the common inductor, and boosting the voltage induced in the secondary side winding, in a first mode in which the voltage is induced in the secondary side winding in the first direction; and a second boost converter including a second switching element controlling the accumulating and discharging of energy of the common inductor, and boosting the voltage induced in the secondary side winding, in a second mode in which the voltage is induced in the secondary side winding in the second direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing an example of an LED driving device;

FIG. 2 is a view showing a power supply device according to an embodiment of the present invention;

FIG. 3 is a view showing operational waveforms for main parts of the power supply device;

FIGS. 4A and 4B are views showing operational states of a boost unit in a first mode and a second mode of the power supply device; and

FIG. 5 is a view showing a power supply device according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

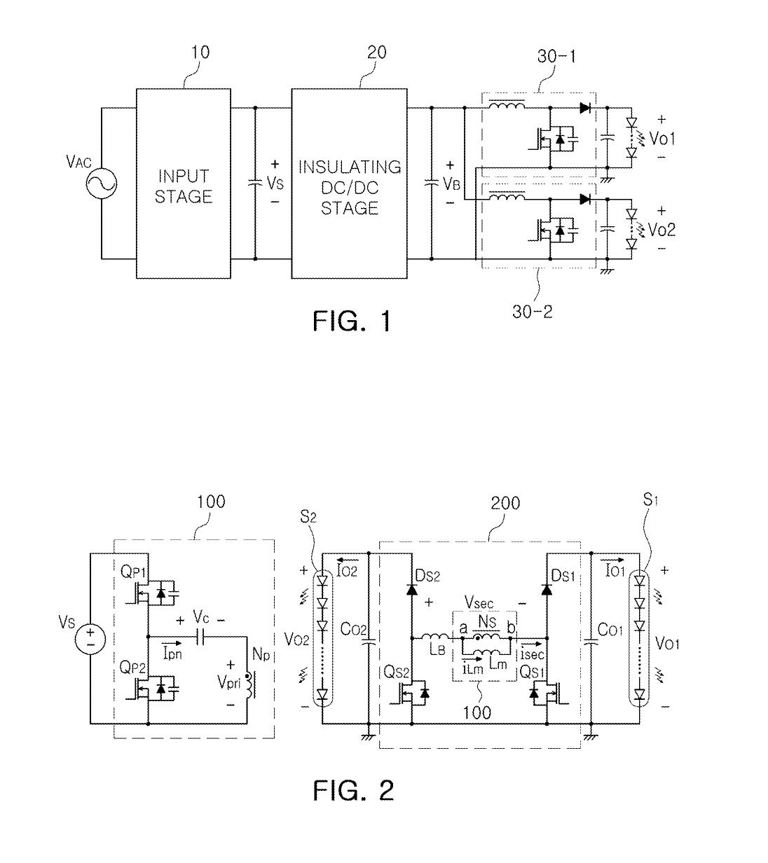

FIG. 1 is a view showing an example of an LED driving device.

Referring to FIG. 1, the LED driving device may include an input stage 10, an insulating direct current to direct current (DC/DC) stage 20, and boost converters 30-1 and 30-2.

The input stage 10 may perform power factor correction on an input power V_{AC} and may transfer the input power having the corrected power factor to the insulating DC/DC stage 20. Therefore, the input stage 10 may include a power factor corrector.

Specifically, the input stage 10 may convert the input power V_{AC} into a direct current voltage V_{S} having a preset magnitude and may provide the direct current voltage V_{S} to the insulating DC/DC stage 20.

Meanwhile, a capacitor for stabilizing the power may be provided between the input stage 10 and the insulating DC/DC stage 20.

The insulating DC/DC stage 20 may convert the direct current voltage V_{S} into a direct current voltage V_{B} having a preset magnitude and may transfer the direct current voltage V_{B} to the boost converters 30-1 and 30-2.

In a similar manner, a capacitor for stabilizing the power may be provided between the insulating DC/DC stage 20 and the boost converters 30-1 and 30-2.

The boost converters 30-1 and 30-2 may output a voltage having a level higher than that of the voltage input thereto through a switching control. That is, the boost converters 30-1 and 30-2 may transfer the voltage having a level higher than that of the direct current voltage V_{B} to respective LED strings.

A method of controlling the boost converters is obvious to those skilled in the art. Therefore, a specific description thereof will be omitted.

Specifically, the boost converter 30-1 may transfer the voltage having a level higher than that of the direct current voltage V_{B} to a first LED string. In addition, the boost converter 30-2 may transfer the voltage having a level higher than that of the direct current voltage V_{B} to a second LED string.

Similarly to the foregoing description, a capacitor for stabilizing the power may be provided between the boost converters 30-1 and 30-2 and the LED strings.

In a case of the above-mentioned LED driving device, since the LED driving device includes three stages, the input stage 10, the insulating DC/DC stage 20, and the boost converters 30-1 and 30-2, a complicated circuit structure thereof is formed. Moreover, a limitation due to a hard switching of the boost converters 30-1 and 30-2 may degrade total efficiency of the driving device and may increase an electromagnetic interference (EMI).

FIG. 2 is a view showing a power supply device according to an embodiment of the present invention.

The power supply device according to the embodiment of the present invention may supply power to the LED string based on the direct current voltage V_{S} from the input stage in the LED driving device shown in FIG. 1.

In addition, the power supply device according to the embodiment of the present invention has a structure in which the insulating DC/DC stage 20 and the boost converters 30-1 and 30-2 shown in FIG. 1 are integrated.

Referring to FIG. 2, the power supply device according to the embodiment of the present invention may include an insulating DC/DC converter unit 100 and a boost unit 200.

The insulating DC/DC converter unit 100 may include a primary side winding and a secondary side winding inductively coupled to the primary winding. In addition, a voltage across the primary side winding may be induced in the secondary side winding in a first direction or a second direction.

Specifically, the insulating DC/DC converter unit 100 may be implemented as a half-bridge DC/DC converter or a full-bridge DC/DC converter.

The present specification will be described based on the half-bridge DC/DC converter for convenience of explanation. However, it may be easily appreciated by those skilled in the art that a configuration according to the embodiment of the present invention described in the present specification may be applied to the full-bridge DC/DC converter.

The insulating DC/DC converter unit 100 may include a third switching element Qₚ₁, a fourth switching element Qₚ₂, a first capacitor, a primary side winding Np, and a secondary side winding Ns.

As shown in FIG. 2, the third switching element Qₚ₁ and the fourth switching element Qₚ₂ may be connected to each other in series. In addition, the first capacitor and the primary side winding Np may be connected to each other in series and may be connected to the fourth switching element Qₚ₂ in parallel.

The boost unit 200 may include a first boost converter boosting the voltage induced in the secondary side winding, in a first mode in which the voltage is induced in the secondary side winding in the first direction.

The first direction is defined as a state in which negative polarity is induced in one end a of the secondary side winding Ns and positive polarity is induced in the other end b of the secondary side winding Ns.

As shown in FIG. 2, the boost unit 200 may include a common inductor L_{B} connected to the secondary side winding Ns in series. The common inductor L_{B} may have one end connected to the one end a of the secondary side winding.

In addition, the boost unit 200 may include a first switching element Qₛ₁ and a first diode Dₛ₁ connected to the other end b of the secondary side winding.

In addition, the boost unit 200 may include a second switching element Qₛ₂ and a second diode Dₛ₂ connected to the other end of the common inductor L_{B}.

The first boost converter may include the common inductor L_{B}, the first switching element Qₛ₁, and the first diode Dₛ₁.

In addition, the boost unit 200 may include a second boost converter boosting the voltage induced in the secondary side winding, in a second mode in which the voltage is induced in the secondary side winding in the second direction.

The second direction is defined as a state in which positive polarity is induced in the one end a of the secondary side winding Ns and negative polarity is induced in the other end b of the secondary side winding Ns.

The second boost converter may include the common inductor L_{B}, the second switching element Qₛ₂, and the second diode Dₛ₂.

Meanwhile, according to the embodiment of the present invention, the power supply device may include a controlling unit controlling the first switching element Qₛ₁, the second switching element Qₛ₂, the third switching element Qₚ₁, and the fourth switching element Qₚ₂.

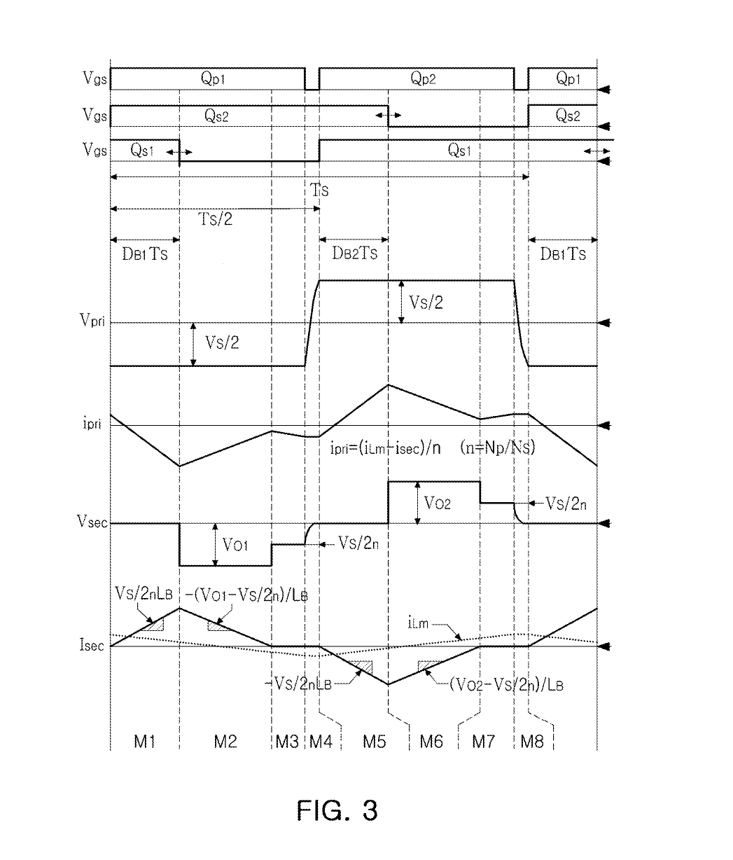

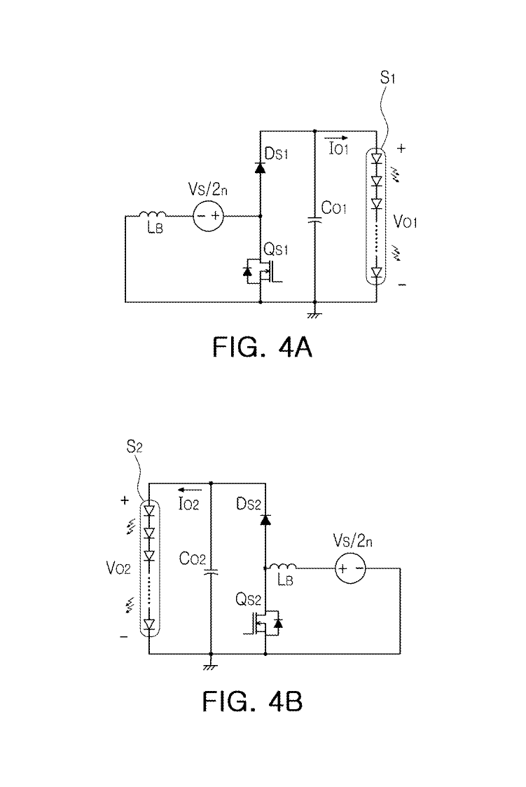

Hereinafter, an operation principle of the power supply device according to the embodiment of the present invention will be described in detail with reference to FIGS. 3 and 4.

FIG. 3 is a view showing operational waveforms for main parts of the power supply device.

FIGS. 4A and 4B are views showing operational states of the boost unit in the first mode and the second mode of the power supply device. FIG. 4A is a view showing the operational state of the boost unit in the first mode. FIG. 4B is a view showing the operational state of the boost unit in the second mode.

Referring to FIGS. 3 and 4, in the first mode, the respective intervals of a circuit operation may be generally divided into a first interval M1, a second interval M2, a third interval M3, and a fourth interval M4.

In the present embodiment, one period of the operation of the power supply device is defined as Ts.

In addition, the first mode may be continued during Ts/2. In addition, the second mode may be continued during Ts/2.

In addition, a duty ratio of the first switching element Q_{S1} in the first mode is defined as D_{B1}.

In addition, a duty ratio of the second switching element Qₛ₂ in the second mode is defined as D_{B2}.

### 1. First Interval M1—Q_{S1}: Turn On, Q_{P1} and Q_{S2}: Turn On

The controlling unit may turn on the third switching element Q_{P1} and the second switching element Qₛ₂ in the first interval M1.

As the third switching element QP1 is turned on, a voltage Vₚᵣᵢ in the primary side winding Np corresponds to half of the direct current voltage V_{S}.

In addition, a primary side current iₚᵣᵢ flowing through the third switching element Q_{P1}, the first capacitor, and the first side winding Np is increased at a predetermined gradient.

Meanwhile, since the second switching element Q_{S2} is turned on, a voltage in the secondary side winding Ns becomes Vs/2n according to a turns ratio of n:1, such that a current i_{sec} flowing through the secondary side winding Ns is increased at a gradient of (Vₛ/2n)/L_{B}.

In the first interval M1, energy may be accumulated in the common inductor L_{B}.

### 2. Second Interval M2—Q_{P1} and Q_{S2}: Turn On, Q_{S1}: Turn Off

The controlling unit may turn off the first switching element Q_{S1} in the second interval M2.

As the first switching element Q_{S1} is turned off, a voltage V₀₁ may be applied to the secondary side winding Ns and the common inductor L_{B}.

Meanwhile, as the second switching element Q_{S2} is turned off, the current i_{sec} flowing through the secondary side winding Ns is decreased at a gradient of −(V₀₁−V_{S}/2n)/L_{B}.

In the second interval M2, the energy accumulated in the common inductor L_{B} may be discharged so as to supply driving power to a first LED string S1.

### 3. Third Interval M3—Q_{P1} and Q_{S2}: Turn On, Q_{S1}: Turn Off

As the switching state in the second interval is continued, the current i_{sec} flowing through the secondary side winding Ns may become zero.

That is, according to the embodiment of the present invention, the power supply device may be controlled to perform a discontinuous mode (DCM) operation.

### 4. Fourth Interval M4—Q_{P1}: Turn Off, Q_{S2}: Turn On, Q_{S1}: Turn Off

Meanwhile, the controlling unit may turn off the third switching element Q_{P1} in the fourth interval M4.

In addition, after a predetermined time of interval has elapsed, the controlling unit may turn on the fourth switching element Q_{P2}.

Referring to FIGS. 3 and 4A, the power supply device may supply the driving power to the first LED string S1 through the method described above.

In addition, referring to FIGS. 3 and 4, in the second mode, the respective intervals of the circuit operation may be generally divided into a fifth interval M5, a sixth interval M6, a seventh interval M7, and an eighth interval M8.

Referring to FIG. 4, since the method of controlling the power supply device in the first mode may be used except for the second switching element Qₛ₂ used in place of the first switching element Q_{S1}, the second diode D_{S2} used in place of the first diode DS1, and the polarity of the voltage induced in the secondary side winding Ns, a description of a specific operation in the second mode will be omitted.

Referring to FIGS. 3 and 4B, the power supply device may supply the driving power to a second LED string S2 through the method described above.

As described above, the power supply device according to the embodiment of the present invention has a structure in which the insulating DC/DC converter and the boost converter are integrated, such that the LED driving device may be simply configured using a small quantity of components.

In addition, the common inductor is used in the plurality of boost converter, such that the LED driving device may be simply configured using a small quantity of components.

In addition, according to the embodiment of the present invention, a current i_{Lm} flowing in a parasitic inductor Lₘ of the secondary side winding Ns may freewheel before respective switching elements are turned on. Therefore, respective switching elements may perform zero-voltage switching (ZVS). In the power supply device according to the embodiment of the present invention, all switching elements may perform zero-voltage switching (ZVS) and a hard switching defect of the existing boost converter may be solved. Therefore, the power supply device according to the embodiment of the present invention may have improved efficiency and may have alleviated EMI.

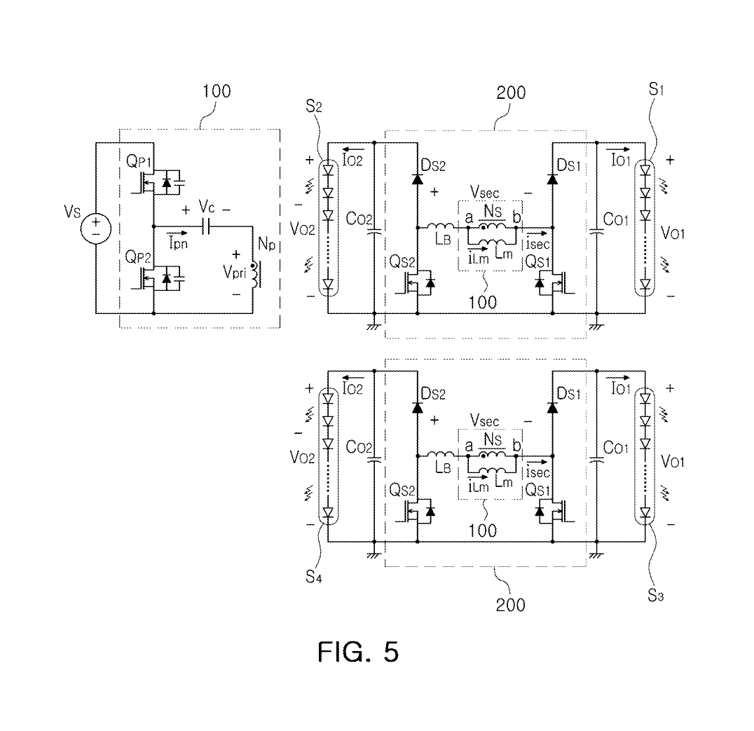

FIG. 5 is a view showing a power supply device according to another embodiment of the present invention.

The power supply device may include a plurality of secondary side windings Ns. In this case, the power supply device may supply power to four LED strings S1, S2, S3, and S4.

In the case in which the above-mentioned method is used, the power supply device according to another embodiment of the present invention may supply the power to three or more LED strings.

As set forth above, according to the embodiment of the present invention, the LED power supply device simplifying a circuit structure may be provided.

In addition, according to another embodiment of the present invention, the LED power supply device improving efficiency may be provided.

While the present invention has been shown and described in connection with the embodiments, it will be apparent to those skilled in the art that modifications and variations can be made without departing from the spirit and scope of the invention as defined by the appended claims.

What is claimed is:

1. A power supply device, comprising:
an insulating direct current to direct current (DC/DC) converter unit including a primary side winding and a secondary side winding inductively coupled to the primary side winding and inducing a voltage in the secondary side winding in a first direction or a second direction; and
a boost unit including a first boost converter boosting the voltage induced in the secondary side winding, in a first mode in which the voltage is induced in the secondary side winding in the first direction, and a second boost converter boosting the voltage induced in the secondary side winding, in a second mode in which the voltage is induced in the secondary side winding in the second direction.

2. The power supply device of claim 1, wherein the insulating DC/DC converter unit includes a half-bridge DC/DC converter or a full-bridge DC/DC converter.

3. The power supply device of claim 1, wherein the boost unit includes a common inductor having one end connected to one end of the secondary side winding in series.

4. The power supply device of claim 3, wherein the boost unit includes a first switching element and a first diode connected to the other end of the secondary side winding.

5. The power supply device of claim 3, wherein the boost unit includes a second switching element and a second diode connected to the other end of the common inductor.

6. The power supply device of claim 1, further comprising a controlling unit controlling the insulating DC/DC converter unit and the boost unit.

7. The power supply device of claim 6, wherein the controlling unit turns on the second switching element in the first mode.

8. The power supply device of claim 6, wherein the controlling unit turns on the first switching element in the second mode.

9. The power supply device of claim 2, wherein the half-bridge DC/DC converter includes a third switching element and a fourth switching element, and
the controlling unit turns off the third switching element and after a predetermined time of interval has elapsed, turns on the fourth switching element, and turns off the fourth switching element and after a predetermined time of interval has elapsed, turns on the third switching element.

10. A power supply device, comprising:
an insulating direct current to direct current (DC/DC) converter unit including a primary side winding and a secondary side winding inductively coupled to the primary side winding and inducing a voltage in the secondary side winding in a first direction or a second direction;
a common inductor connected to the secondary side winding in series;
a first boost converter including a first switching element controlling accumulating and discharging of energy of the common inductor, and boosting the voltage induced in the secondary side winding, in a first mode in which the voltage is induced in the secondary side winding in the first direction; and
a second boost converter including a second switching element controlling the accumulating and discharging of energy of the common inductor, and boosting the voltage induced in the secondary side winding, in a second mode in which the voltage is induced in the secondary side winding in the second direction.
